(19) United States
(12) Patent Application Publication
(10) Pub. No.: US 2012/0162762 A1
(43) Pub. Date: Jun. 28, 2012

(54) STEREOSCOPIC DISPLAY UNIT AND BARRIER DEVICE

(75) Inventor: Yuji Takahashi, Miyagi (JP)

(73) Assignee: SONY CORPORATION, Tokyo (JP)

(21) Appl. No.: 13/333,533

(22) Filed: Dec. 21, 2011

(30) Foreign Application Priority Data
Dec. 28, 2010 (JP) 2010-291829

(51) Int. Cl. G02B 27/22

(52) U.S. Cl. 359/462

(57) ABSTRACT

A barrier device includes a plurality of slits allowing image-displaying light beams to pass therethrough. The plurality of slits are arranged in an array at horizontal intervals which decrease as an outward distance from a mid-position of the array increases.

### CROSS REFERENCES TO RELATED APPLICATIONS

The present application claims priority to Japanese Priority Patent Application JP 2010-291829 filed in the Japan Patent Office on Dec. 28, 2010, the entire content of which is hereby incorporated by reference.

### BACKGROUND

The present disclosure relates to a stereoscopic display unit and a barrier device that enable a stereoscopic vision by means of a parallax barrier system.

A stereoscopic display unit of a parallax barrier system has been known as one of the stereoscopic display systems that allows a stereoscopic vision by naked eyes without the need for wearing special eyeglasses. As a general example of a configuration of the stereoscopic display unit by means of the parallax barrier system, there is a configuration in which a parallax barrier is disposed to oppose a front surface of a display section of a liquid crystal panel or the like. There is also a configuration in which a transmission-type display panel is used for a display section, and the parallax barrier is arranged on the rear side (on the backlight side) of the display panel, as disclosed in Japanese Unexamined Patent Application Publication No. 2007-187823 (FIG. 3).

In the parallax barrier system, the stereoscopic vision is performed by spatially dividing and displaying parallax images for stereoscopic vision (a parallax image for right-eye and a parallax image for left-eye in the case of two viewpoints) on the display section, and separating, in accordance with a parallax, the parallax images in a horizontal direction by the parallax barrier serving as a parallax separator. As a general configuration of the parallax barrier, there is a configuration in which a slit that transmit light and a shielding section that shields the light are provided alternately in a horizontal direction (in a lateral direction).

### SUMMARY

In a stereoscopic display unit of a parallax barrier system, a stereoscopic vision is realized by allowing lights from separate parallax images to enter right and left eyes of an observer by utilizing a parallax separation function of a parallax barrier. Thus, in order to realize excellent stereoscopic vision, it is necessary that a relative positional relation between, for example, each pixel of a display panel and slits of the parallax barrier be aligned accurately according to design values. For example, if positions of slits deviate from the design values by some factor, quality of the stereoscopic vision is likely to be deteriorated.

However, when, for example, a plurality of layers having a refractive index difference (for example, an air layer and a substrate of the parallax barrier) are interposed between the display section and the slits in a configuration in which the parallax barrier is disposed on the rear side of the display panel, optical locations of the slits are deviated from the design values due to the presence of that refractive index difference. Hence, it is likely that excellent stereoscopic displaying may not be performed.

It is desirable to provide a stereoscopic display unit and a barrier device capable of performing excellent stereoscopic displaying.

A stereoscopic display unit according to an embodiment of the technology includes: a display section; and a barrier device disposed on a rear side of the display section to include a plurality of slits allowing image-displaying light beams to pass therethrough toward the display section. The plurality of slits are arranged in a fashion of an array at horizontal intervals which decrease as an outward distance from a mid-position of the array increases.

A barrier device according to an embodiment of the technology includes: a plurality of slits allowing image-displaying light beams to pass therethrough. The plurality of slits are arranged in an array at horizontal intervals which decrease as an outward distance from a mid-position of the array increases.

In the stereoscopic display unit and the barrier device according to the embodiments of the technology, the intervals (or barrier pitches) of the plurality of slits decrease as the outward distance from the mid-position of the array increases. Thus, for example, when a plurality of layers having a refractive index difference are interposed between the display section and the slits, optical displacements in slit locations caused by the refractive index difference is compensated.

According to the stereoscopic display unit and the barrier device of the embodiments of the technology, the intervals of the plurality of slits decrease as the outward distance from the mid-position of the array increases. This makes it possible to, when a plurality of layers having a refractive index difference are interposed between the display section and the slits, for example, compensate optical displacements in slit locations caused by that refractive index difference. Hence, it is possible to perform excellent stereoscopic displaying.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view illustrating an example of an overall configuration of a stereoscopic display unit according to an embodiment of the technology.

FIGS. 2A and 2B are cross-sectional views each illustrating a configuration example of a backlight having a barrier function.

FIG. 3 is a perspective view illustrating an electrode configuration of a light modulation device in the backlight illustrated in FIGS. 2A and 2B.

FIG. 4 describes a state of an exit of light beams in the backlight illustrated in FIGS. 2A and 2B.

FIG. 5 is a cross-sectional view illustrating a basic design example of a barrier device.

FIG. 6 describes optical displacement in locations with respect to design values caused by a refractive index difference.

FIG. 7 describes an incidence angle and an amount of optical displacement in locations.

FIG. 8 describes an incidence angle with respect to a first viewpoint in the case of nine viewpoints.

FIG. 9 describes an incidence angle with respect to a ninth viewpoint in the case of the nine viewpoints.

FIG. 10 describes the minimum incidence angle and the maximum incidence angle.

FIG. 11 describes the incidence angle and the amount of optical displacement in locations.

FIG. 12 describes calculation of the displacement amount.

FIG. 13 describes the calculation of the displacement amount with respect to a first view position.

FIG. 14 describes the calculation of the displacement amount with respect to a second view position.

FIG. 15 describes positions of slits following the optimization.

FIG. 16 is a plan view illustrating a first specific example of the arrangement of the slits.

FIG. 17 is a plan view illustrating a second specific example of the arrangement of the slits.

FIG. 18 is a plan view illustrating a third specific example of the arrangement of the slits.

### DETAILED DESCRIPTION

Hereinafter, an embodiment of the technology will be described in detail with reference to the drawings.

### [Overall Configuration of the Stereoscopic Display Unit]

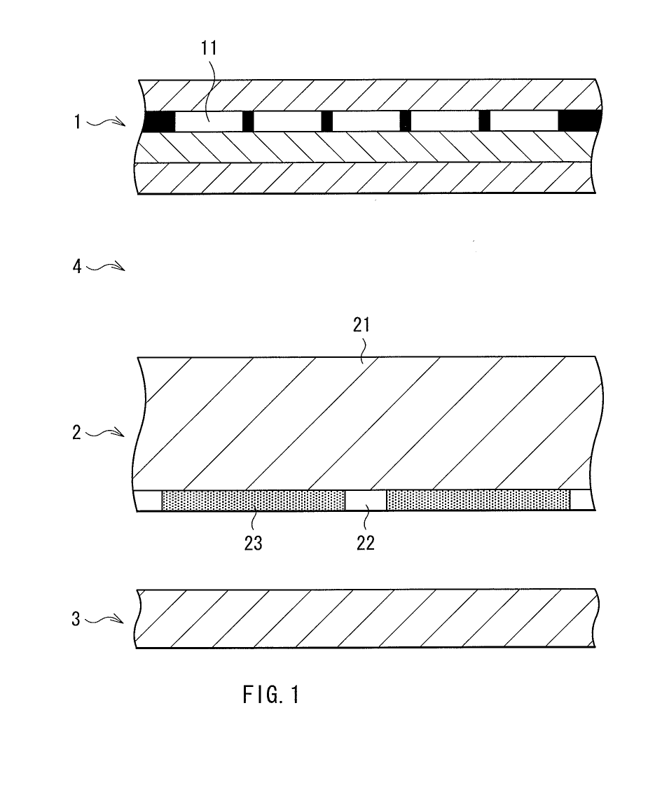

FIG. 1 illustrates an example of a configuration of a stereoscopic display unit according to one embodiment of the technology. The stereoscopic display unit is provided with: a display section 1 that performs image displaying; a barrier device (a parallax barrier) 2 disposed on the rear side of the display section 1 and which allows light used for the image displaying to exit therefrom (i.e., to pass therethrough); and a surface light source 3.

The display section 1 is structured by a transmission two-dimensional display panel such as, but not limited to, a transmission liquid crystal display panel. The display section 1 may have a plurality of pixels including pixels for R (red), pixels for G (green), and pixels for B (blue), for example. These pixels may be arranged in matrix. The display section 1 modulates, for each pixel, light derived from the barrier device 2 and the surface light source 3 in accordance with image data, to perform the two-dimensional image displaying.

The stereoscopic display unit is capable of selectively switching between the two-dimensional (2D) display mode and three-dimensional (3D) display mode optionally when the barrier device 2 is configured by the parallax barrier of a variable type. The switching between the two-dimensional display mode and the three-dimensional display mode is made possible by performing a switching control of the image data displayed on the display section 1 and by performing an on-and-off switching control of a parallax separation function of the barrier device 2. In this embodiment, the display section 1 selectively switches between an image based on three-dimensional image data and an image based on two-dimensional image data to display those images. As used herein, the term “three-dimensional image data” refers to data including a plurality of parallax images that correspond to a plurality of viewing angle directions in three-dimensional displaying. For example, the three-dimensional image data may be data including a parallax image for right-eye displaying and a parallax image for left-eye displaying when performing the three-dimensional displaying of a binocular type. A composite image in which a plurality of striped parallax images are included may be displayed within one screen when performing the displaying based on the three-dimensional display mode, for example.

The surface light source 3 is configured by a fluorescent lamp such as CCFL (Cold Cathode Fluorescent Lamp), or LED (Light-Emitting Diode), for example. The barrier device 2 separates, in a plurality of viewpoint directions, the plurality of perspective images included in the parallax composite image displayed on the display section 1 so that the stereoscopic vision is enabled, when performing the three-dimensional displaying. The barrier device 2 is so disposed to oppose the display section 1, with a predetermined positional relationship relative to the display section 1, as to enable a stereoscopic vision. The barrier device 2 has a substrate 21, a shielding section 23 which shields light, and a slit 22 serving as a parallax separation section. Each of the slits 22 allows the light to transmit therethrough or allows the light to exit therefrom, and is so associated, with a predetermined condition, to each pixel 11 of the display section 1 as to enable the stereoscopic vision.

The barrier device 2 may be a parallax barrier of a fixed type, or a parallax barrier of a variable type. In one embodiment where the fixed parallax barrier is employed, a parallax barrier may be used in which a pattern (such as a thin-film metal) serving as the slit 22 and the shielding section 23 is formed on a surface of a transparent parallel flat plate (such as the substrate 21), for example. In one embodiment where the variable parallax barrier is employed, a displaying function (a light modulating function) by means of a liquid crystal display device of a backlight type may be used to selectively form the pattern serving as the slit 22 and the shielding section 23, for example.

In both of the embodiments where the fixed type configuration and the variable type configurations are used, respectively, a configuration is employed in which the barrier device 2 is disposed, on the rear side of the display section 1, to oppose the display section 1 with an air layer 4 (a first layer) in between, and in which the substrate 21 (a second layer) having a refractive index different from that of the air layer 4 is disposed between the slit 22 (as well as the shielding section 23) and the air layer 4. An interval of arrangement of the slits 22 is so optimized as to compensate optical displacements in slit locations caused by a refractive index difference between the air layer 4 and the substrate 21. In this embodiment, the slits 22 are arranged with a pitch in between in a horizontal direction, and are so arranged that the pitches in the horizontal direction are narrowed as approaching a peripheral region from a central region thereof. In other words, the plurality of slits 22 are arranged in a fashion of an array at horizontal intervals which decrease as an outward distance from a mid-position of the array increases. The optical displacements in locations of the slits 22 and optimization thereof will be described later in detail.

### [Modification of Barrier Device 2]

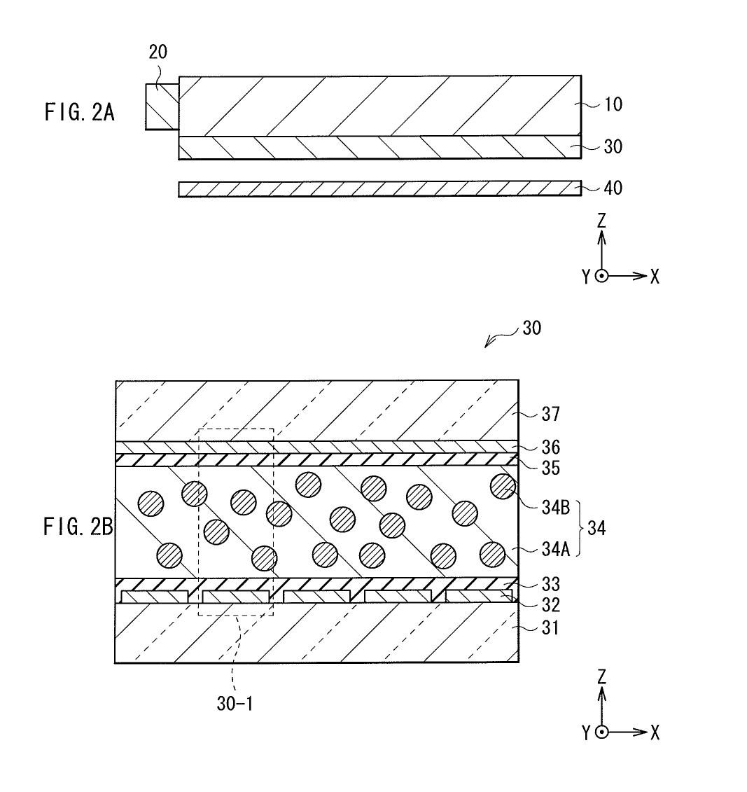

FIG. 1 illustrates the embodiment having the configuration in which the barrier device 2 and the surface light source 3 are used. Alternatively, in the embodiment where the variable parallax barrier is employed, PDLC (Polymer-Dispersed Liquid Crystal) may be used to employ an edge-light configuration, for example. A backlight having a barrier function illustrated in FIGS. 2A and 2B may be used instead of the barrier device 2 and the surface light source 3, for example.

The backlight having this barrier function is provided with: a light guide member such as a light guide plate and a light guide sheet (hereinafter referred to as a “light guide plate 10” in this embodiment); a light source 20 disposed on a side face of the light guide plate 10; and a light modulation device 30 and a reflector 40 both disposed on the rear side of the light guide plate 10.

The light guide plate 10 guides light from the light source 20, disposed on the side face of the light guide plate 10, to an upper face of the light guide plate 10. The light guide plate 10 has a shape corresponding to the display section 1 (illustrated in FIG. 1) disposed on the upper face of the light guide plate 10. For example, the light guide plate 10 has a rectangular parallelepiped shape surrounded by the upper face, a lower face, and the side faces. The light guide plate 10 has a function of scattering the light of the light source 20 entered from the side face and uniformizing the same, for example. The light guide plate 10 includes primarily a transparent thermoplastic resin, which can be a polycarbonate resin (PC), an acrylic resin (polymethylmethacrylate (PMMA)), or other suitable material.

The light source 20 is a linear light source, which can be a hot-cathode fluorescent lamp (HCFL), the CCFL, a plurality of LEDs disposed in a line, or other suitable light emitter, for example. The light source 20 may be provided only on one side face of the light guide plate 10 as illustrated in FIG. 2A, or may be provided on two side faces, on three side faces, or on all of side faces of the light guide plate 10.

The reflector 40 returns the light, leaked from the back of the light guide plate 10 through the light modulation device 30, toward the light guide plate 10, and has a function such as reflection, diffusion, and scattering, for example. The reflector 40 thus enables to efficiently use the emission light from the light source 20, and serves to improve a front luminance as well. The reflector 40 includes a material or a member, which can be foamed polyethylene terephthalate (PET), a silver-deposited film, a multilayer reflection film, white PET, or other suitable material or member.

In this embodiment, the light modulation device 30 is closely attached to the back (i.e., the lower face) of the light guide plate 10 without interposing an air layer in between. For example, the light modulation device 30 is adhered to the back of the light guide plate 10 by an adhesive (not illustrated). As illustrated in FIG. 2B, the light modulation device 30 may be provided with a transparent substrate 31, a bottom electrode 32, an orientation film 33, a light modulation layer 34, an orientation film 35, a top electrode 36, and a transparent substrate 37, which are disposed in order from a side on which the reflector 40 is disposed, for example.

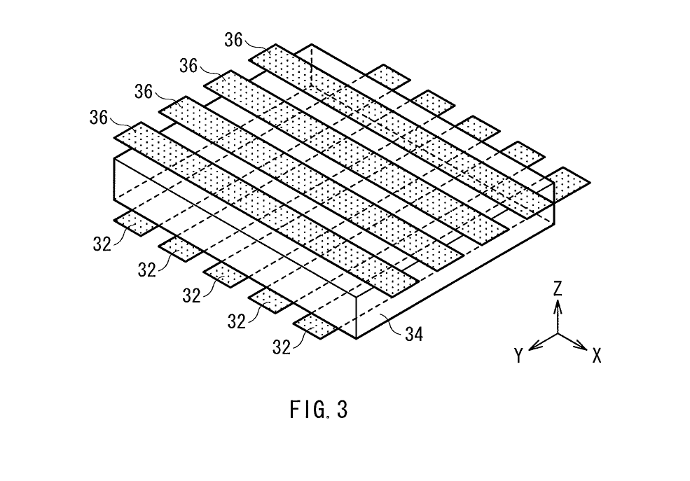

Each of the transparent substrates 31 and 37 supports the light modulation layer 34, and in some embodiments, is configured by a substrate transparent to visible light, which can be a glass plate, a plastic film, or other suitable transparent member. The bottom electrode 32 is provided on a surface of the transparent substrate 31 facing the transparent substrate 37. For example, as illustrated in a partial cutout of the light modulation device 30 in FIG. 3, the bottom electrode 32 has a strip-like shape extending in one direction in a plane. The top electrode 36 is provided on a surface of the transparent substrate 37 facing the transparent substrate 31. For example, the top electrode 36 has a strip-like shape extending in one direction in the plane in a direction crossing (i.e., orthogonal to) the extending direction of the bottom electrode 32, as illustrated in FIG. 3.

A configuration (or the shape) of each of the bottom electrode 32 and the top electrode 36 depends on a driving scheme. For example, in one embodiment where these electrodes 32 and 36 each have the strip-like shape as described above, each of the electrodes 32 and 36 may be driven by a simple-matrix driving scheme. In one embodiment where one of the bottom electrode 32 and the top electrode 36 has a solid film and the other of the bottom electrode 32 and the top electrode 36 has a fine rectangular shape, each of the bottom electrode 32 and the top electrode 36 may be driven by an active-matrix driving scheme. Also, in one embodiment where one of the bottom electrode 32 and the top electrode 36 has a solid film and the other of the bottom electrode 32 and the top electrode 36 has a block configuration provided with fine interconnection lines, a segment scheme may be employed, where respective segmented blocks of the block configuration are driven independently, for example.

At least the top electrode 36 (the electrodes on the upper face side of the backlight) in the bottom electrode 32 and the top electrode 36 includes a transparent conductive material, which can be indium tin oxide (ITO) or other suitable material. The bottom electrode 32 (the electrodes on the lower face side of the backlight) may not include a transparent material. For example, the bottom electrode 32 may include a metal. In one embodiment where the bottom electrode 32 is configured of a metal, the bottom electrode 32 also has a function of reflecting the light entering the light modulation device 30 from the back of the light guide plate 10, as with the reflector 40. In this case, the reflector 40 thus may not be provided.

When the bottom electrode 32 and the top electrode 36 are viewed from a direction of normal of the light modulation device 30, each region corresponding to a portion where the bottom electrode 32 and the top electrode 36 face each other in the light modulation device 30 structures a light modulating cell 30-1. Each of the light modulating cells 30-1 may be separately and independently driven by applying a predetermined voltage to the bottom electrode 32 and the top electrode 36, and expresses a transparency or a scattering property to the light from the light source 20 in response to a magnitude of voltage value applied to the bottom electrode 32 and the top electrode 36.

The backlight is capable of partially switching black display and white display in response to the voltage applied across the bottom electrode 32 and the top electrode 36 of the light modulation device 30. This enables to form a barrier pattern equivalent to that achieved by the slits 22 and the shielding sections 23 of the barrier device 2 illustrated in FIG. 1.

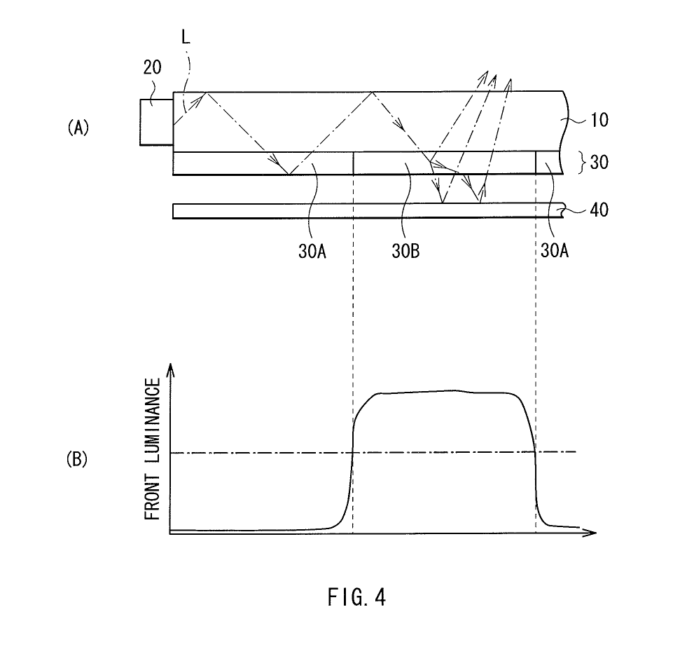

As illustrated in FIG. 2B, the light modulation layer 34 is a composite layer including a bulk 34A and a plurality of microparticles 34B dispersed in the bulk 34A, for example. The bulk 34A and the microparticles 34B both have an optical anisotropy. It is preferable, but not required, that an ordinary light refractive index of the bulk 34A and that of the microparticle 34B be equal to each other, and an extraordinary light refractive index of the bulk 34A and that of the microparticle 34B be equal to each other. In this case, for example, there is hardly any difference in the refractive index in all of directions including the front direction and oblique directions in a region in which no voltage is applied across the bottom electrode 32 and the top electrode 36 (i.e., a transparent region 30A illustrated in (A) of FIG. 4), and thus high transparency is obtained. Thereby, light traveling in the front direction and light traveling in the oblique direction transmit through the light modulation layer 34 without being scattered in the light modulation layer 34, for example. As a result, as illustrated in (A) and (B) of FIG. 4, light L from the light source 20 is totally reflected by an interface of the transparent region 30A (i.e., an interface between the transparent substrate 31 or the light guide plate 10 and air), for example. Consequently, a luminance of the transparent region 30A (a luminance in black displaying) becomes lower than that in a case where the light modulation device 30 is not provided (denoted by a long-dashed-short-dashed line in (B) of FIG. 4). This allows the transparent region 30A to function as the shielding sections 23 of the barrier device 2 illustrated in FIG. 1.

Also, in a region in which the voltage is applied across the bottom electrode 32 and the top electrode 36 (i.e., a scatter region 30B illustrated in (A) of FIG. 4), the difference in the refractive index increases in all of the directions including the front direction and the oblique directions in the light modulation layer 34, and thus high scattering property is obtained. Thereby, the light traveling in the front direction and the light traveling in the oblique direction are scattered in the light modulation layer 34, for example. As a result, as illustrated in (A) and (B) of FIG. 4, the light L from the light source 20 transmits through the interface of the scatter region 30B (i.e., the interface between the transparent substrate 31 or the light guide plate 10 and air), and the light having transmitted therethrough toward the reflector 40 is reflected by the reflector 40 and then transmits through the light modulation device 30, for example. Consequently, the luminance of the scatter region 30B becomes extremely higher than that in the case where the light modulation device 30 is not provided (denoted by a long-dashed-short-dashed line in (B) of FIG. 4), and moreover, a luminance in partial white displaying (a luminance protrusion) increases by a decreased amount of the luminance in the transparent region 30A. This allows the scatter region 30B to function as the slits 22 of the barrier device 2 illustrated in FIG. 1.

In the embodiment where the backlight having the barrier function is used, a configuration is employed as well in which the backlight is disposed, on the rear side of the display section 1, to oppose the display section 1 with the air layer 4 (the first layer) in between, and in which the second layer (mainly the light guide plate 10 and the transparent substrate 37) having a refractive index different from that of the air layer 4 is disposed between the slit 22 as well as the shielding section 23 (i.e., the light modulation layer 34) and the air layer 4, as in the barrier device 2 illustrated in FIG. 1.

### [Design Values of Slits 22 and Optical Displacements in Locations]

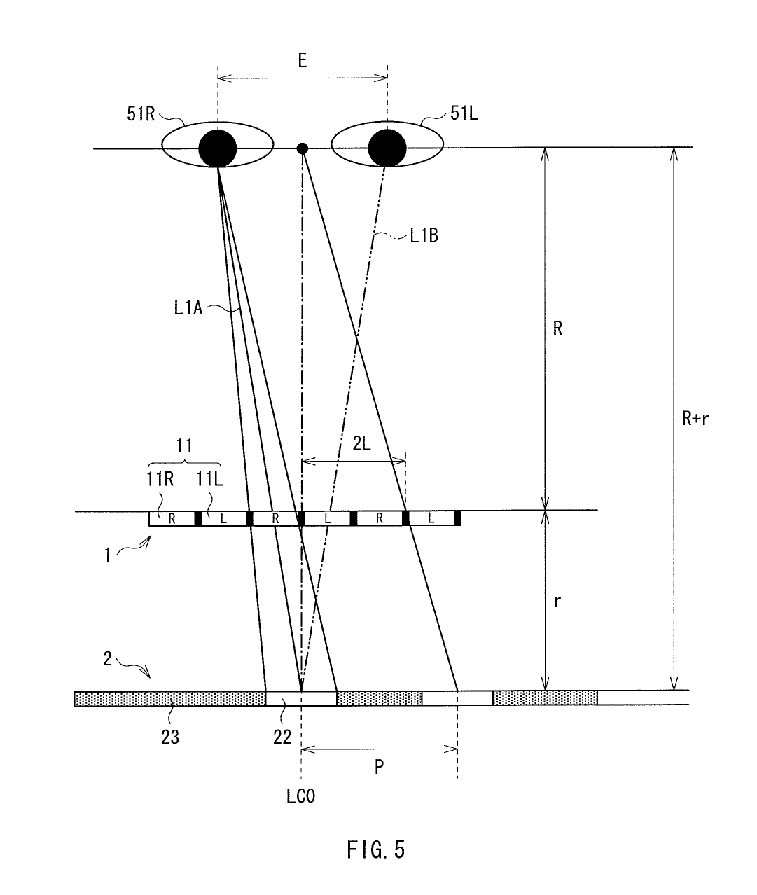

FIG. 5 illustrates an example of a basic design for an arrangement of each section in the stereoscopic display unit when the binocular scheme is employed, for example. It is to be noted that, in FIG. 5, the optical displacements in locations resulting from the refractive index difference between the display section 1 and the slits 22 as well as the shielding sections 23 of the barrier device 2 have not been considered. In FIG. 5, “L” denotes a pitch (a pixel pitch) of the pixel 11 (a left-eye pixel 11L and a right-eye pixel 11R) in the display section 1, “R” denotes a distance of view between an observer (a left eye 51L and a right eye 51R) and the display section 1, and “r” denotes a distance (a barrier distance) between the display section 1 (the pixels 11) and the slits 22 as well as the shielding sections 23 of the barrier device 2. Also, “P” denotes the pitch in the horizontal direction (the barrier pitch) of the slits 22, “E” denotes a pitch (a distance between the viewpoints) between the left eye 51L and the right eye 51R, and “LC0” denotes a mid-position (a mid-position of displaying) of the display section 1.

When assuming that there is no layer having the refractive index difference between the display section 1 and the slits 22, a light beam L1B that enters the left-eye 51L of the observer will only be the light derived from the left-eye pixel 11L and a light beam L1A that enters the right-eye 51R will only be the light derived from the right-eye pixel 11R, by allowing the arrangement of each section to have the design values satisfying the following relationships. This allows performing the binocular stereoscopic vision.

L:r=E:(R+r)

2L:R=P:(R+r)

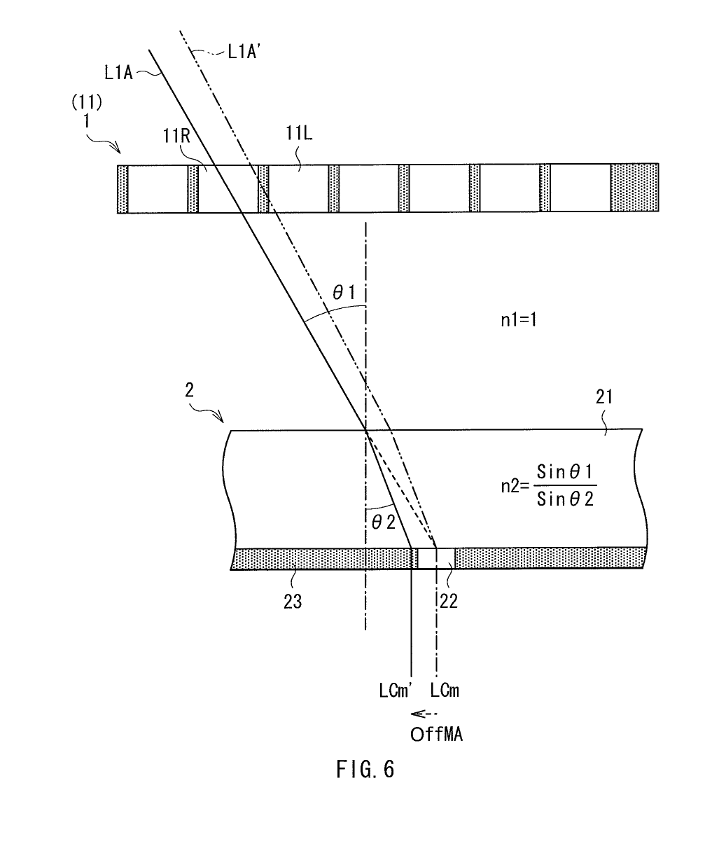

In practice, however, the substrate 21 having the refractive index different from that of the air layer 4 is disposed between the slits 22 as well as the shielding sections 23 and the air layer 4. Thus, the optical displacements in locations illustrated in FIG. 6 occur if a configuration according to the design values described above is established. FIG. 6 illustrates a case in which the light beam L1A entering the right-eye 51R is exemplified, although the same is true for a case of the light beam L1B entering the left-eye 51L. The following relationship is established according to the Snell's law, where “θ1” is an incidence angle of the light L1A from the air layer 4 to the substrate 21, “θ2” is an incidence angle of the light L1A from the substrate 21 to the air layer 4, “n1” is a refractive index of the air layer 4 (n1=1.0), and “n2” is a refractive index of the substrate 21 is n2.

n2=Sin θ1/Sin θ2

When defining a mid-position of the slit 22 (the mid-position of the slit before optimizing the refractive index), observed from the right-eye 51R on the premise that there is no refractive index difference, as LCm, a position LCm', which is optically displaced due to an influence of the refractive index difference (an amount of displacement OffMA), is observed when that mid-position LCm before the optimization of the refractive index is observed from the right-eye 51R in a state in which the refractive index difference is present. This results in a state in which the right-eye pixel 11R, which is supposed to be seen from the right-eye 51R originally, is shielded. This also results in a state in which a light beam L1A′ from the left-eye pixel 11L, which is supposed to be shielded for the right-eye 51R originally, is seen by the right-eye 51R.

### [Outline of Optimization of Arrangement of Slits 22]

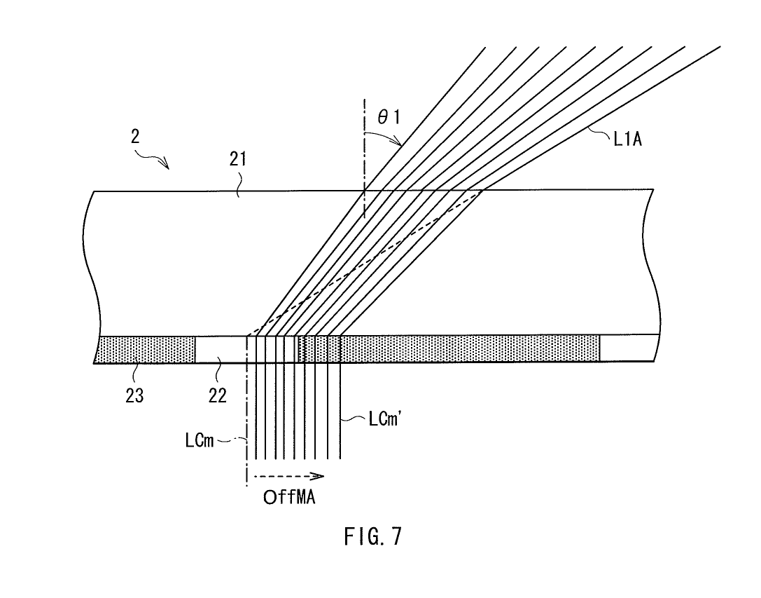

In accordance with the Snell's law as described above, the incidence angles θ1 and θ2 are in a proportional relationship in terms of sinusoid. Thus, the amount of displacement OffMA described above becomes larger as the incidence angle θ1 becomes larger as illustrated schematically in FIG. 7. In other words, the amount of displacement OffMA is not uniform, and varies depending on a position of observation (the view position).

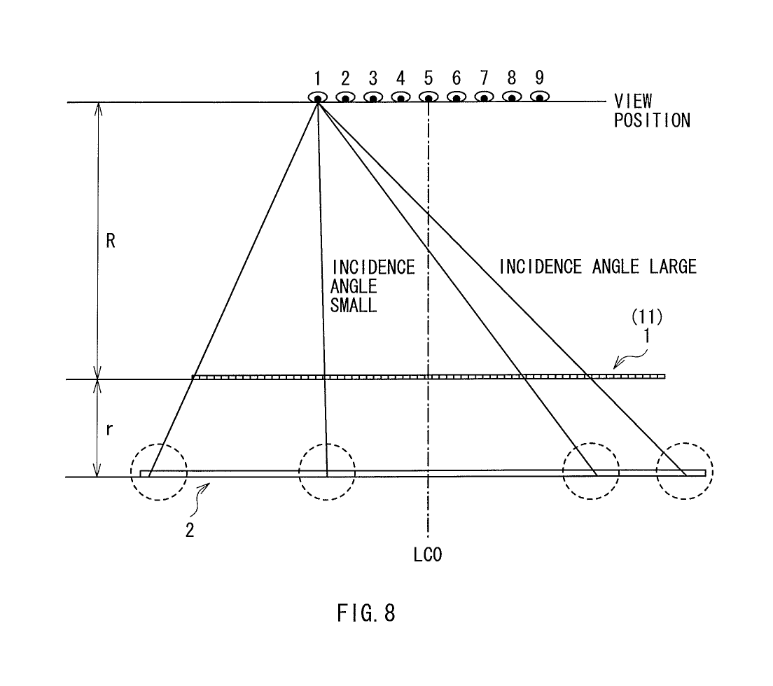

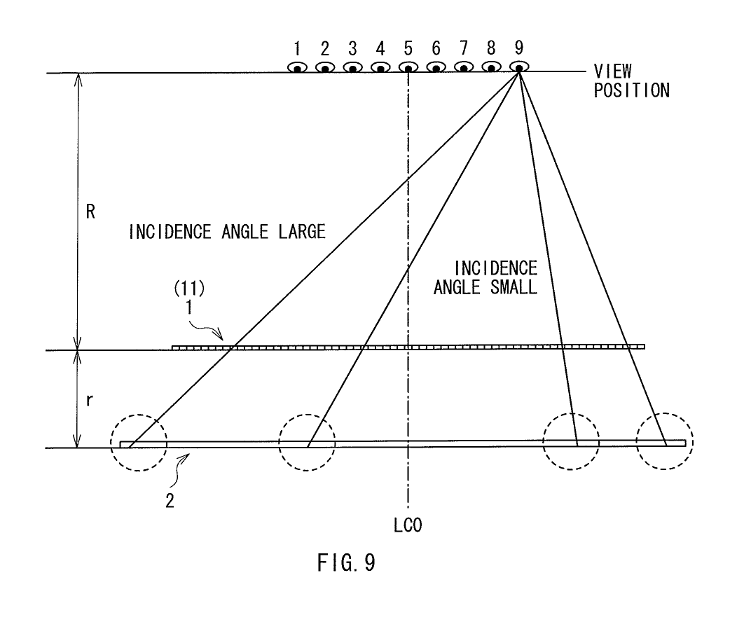

FIGS. 8 and 9 each illustrate a relationship of incidence angles at a view position which is located at an outermost position (a first view position and a ninth view position, respectively) in an example where there are nine viewpoints. A parallax barrier scheme is designed to guarantee the 3D quality even when a view position is shifted at a proper distance of vision relative to a screen, except for reverse viewing. As is illustrated in FIGS. 8 and 9, an angular relationship between the view position and the pixel 11 differs depending on each of the view positions. On the other hand, the slit 22 of the barrier device 2 is common to any view position. It is desirable that the single slit 22 be designed to guarantee the 3D quality for all of the viewpoints and the pixels within a range of an effective viewing angle θ0. However, the 3D quality may not be guaranteed perfectly for all of those viewpoints and pixels since the amount of displacement varies depending on incidence angle as described above.

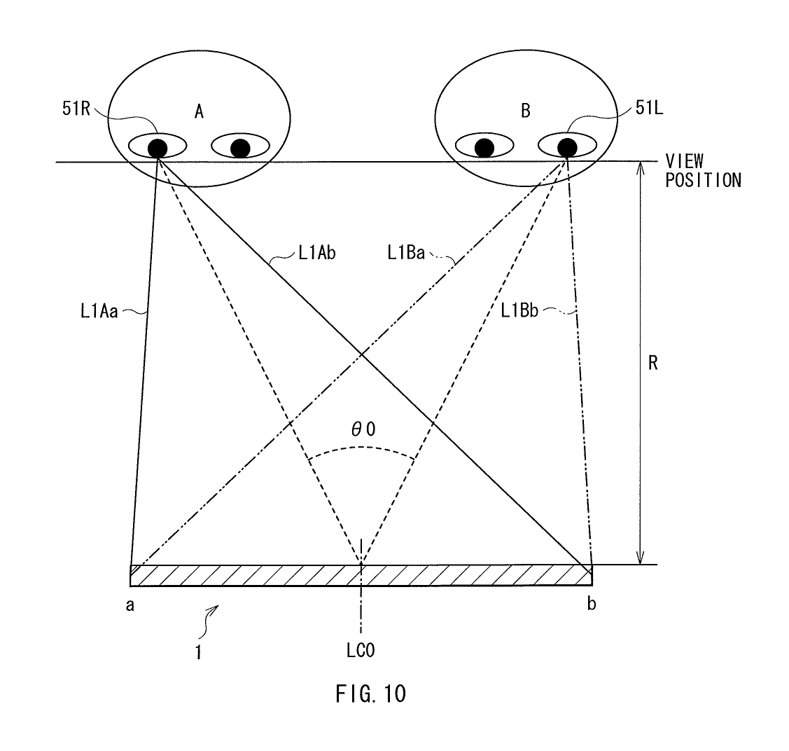

To address this, an arrangement of any slit 22 is optimized within the range of the effective viewing angle θ0, by using a mean value of an amount of displacement at a minimum incidence angle and an amount of displacement at a maximum incidence angle. As illustrated in FIG. 10, the mid-position (the mid-position of displaying) LC0 of the display section 1 is determined as the center of observation to define the effective viewing angle θ0. The effective viewing angle θ0 is determined by such as the proper distance of vision and the number of viewpoints. For example, the proper distance of vision is 1.5 meters and the effective viewing angle θ0 is 22 degrees when a screen size of the display section 1 is 40 inches and the number of viewpoints is nine.

As illustrated in FIG. 10, when defining a first observed position and a second observed position which are located mutually at the outermost positions within the range of the effective viewing angle θ0 as A and B, respectively, the right-eye 51R in the first observed position A (the first view position) and the left-eye 51L in the second observed position B (the second view position) are at the view positions which are located mutually at the outermost positions within the range of the effective viewing angle θ0, respectively. Here, the incidence angle becomes the largest when a second end “b” is seen (a light beam L1Ab) from the right-eye 51R in the first observed position A, and when a first end “a” is seen (a light beam L1Ba) from the left-eye 51L in the second observed position B. The incidence angle becomes the smallest when the second end “b” is seen (a light beam L1Bb) from the left-eye 51L in the second observed position B, and when the first end “a” is seen (a light beam L1Aa) from the right-eye 51R in the first observed position A.

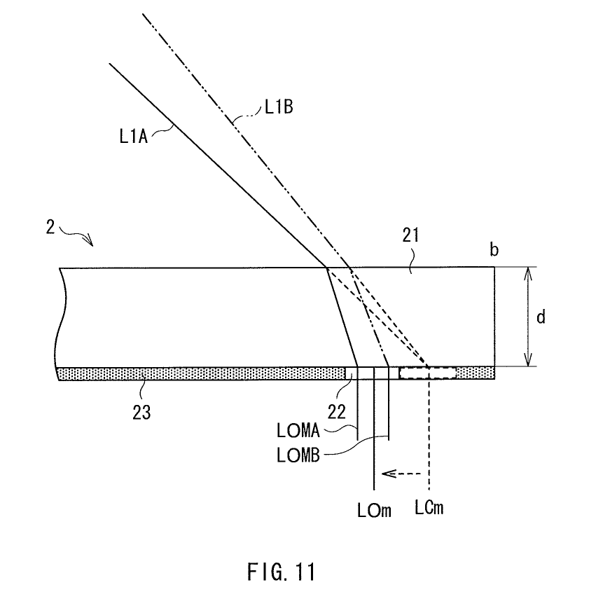

The arrangement of the slits 22 may be so optimized that the amounts of displacement become the minimum for the first view position (the right-eye 51R in the first observed position A) and the second view position (the left-eye 51L in the second observed position B). FIG. 11 illustrates a case in which: the mid-position of the slit 22 before the optimization, observed from the first and the second view positions on the premise that there is no refractive index difference, is defined as LCm; a first displaced position, which is observed as being optically displaced due to the influence of the refractive index difference when the mid-position LCm before the optimization is observed from the first view position in a state in which the refractive index difference is present, is defined as LOMA; and a second displaced position, which is observed as being optically displaced due to the influence of the refractive index difference when the mid-position LCm before the optimization is observed from the second view position in a state in which the refractive index difference is present, is defined as LOMB. In this case, a mid-position LOm following the optimization of the slits 22 may be set to a midpoint of the first displaced position LOMA and the second displaced position LOMB. Incidentally, “d” in FIG. 11 denotes a thickness of the substrate 21 of the barrier device 2.

### [Specific Calculation Example of Arrangement of Slits 22]

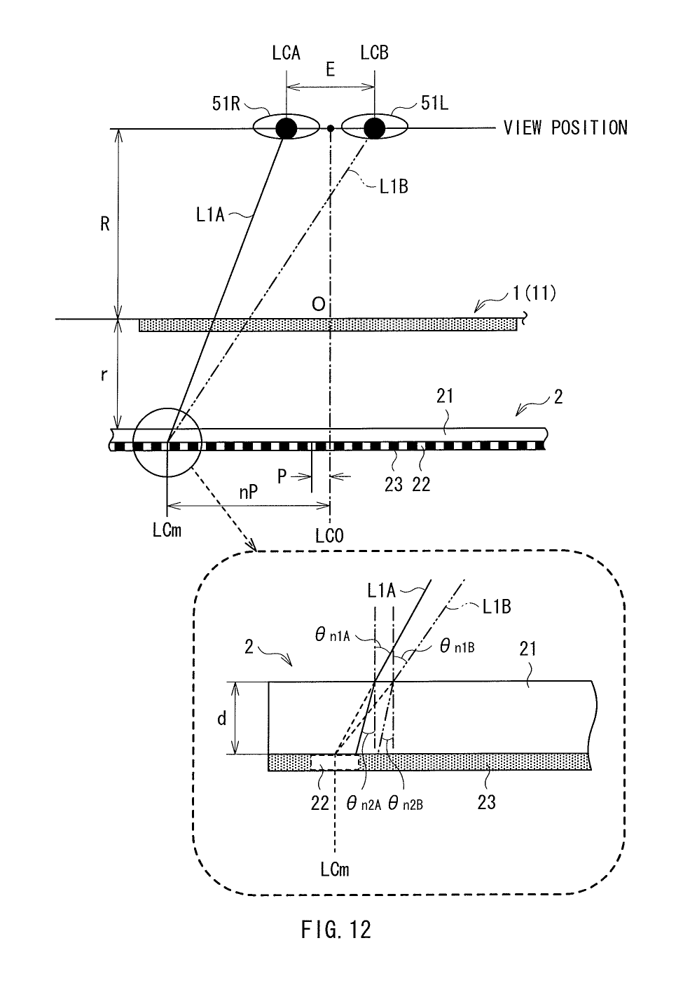

A specific design example in performing the optimization of the arrangement of the slits 22 illustrated, for example, in FIG. 11 will now be described with reference to FIGS. 12 to 15. Note that the same or equivalent elements in FIGS. 12 to 15 as those in FIGS. 5 to 11 are denoted with the same reference numerals having the same meanings, and will not be described in detail.

FIG. 12 illustrates a design example based on the binocular scheme as in FIG. 5. In this design example, the following relationships are established as described above.

L:r=E:(R+r)

2L:R=P:(R+r)

From these relationships, the following expressions are established.

r=LR/(E−L)

P=2L+2Lr/R

Here, symmetry is established with respect to a line at a displaying mid-position LC0 of the display section 1, and only one side of the symmetry is taken into account. The center of coordinate of the slits 22 is 0 (zero). A coordinate of the mid-position LCm of the n-th slit 22 before the optimization, located on the right side of the center, is defined as LCm=nP.

When a coordinate of the proper distance of vision of the first view position (the right-eye 51R) is defined as LCA and a coordinate of the proper distance of vision of the second view position (the left-eye 51L) is defined as LCB, an incidence angle θ_{n1A} of the light beam L1A corresponding to the first view position LCA relative to the mid-position LCm of the slit 22 before the optimization is defined as follows.

θ_{n1A}=tan⁻¹{(LCm−LCA)/(R+r)}

Similarly, an incidence angle θ_{n1B} of the light beam L1B corresponding to the second view position LCB relative to the mid-position LCm of the slit 22 before the optimization is defined as follows.

θ_{n1B}=tan⁻¹{(LCm−LCB)/(R+r)}

A refraction angle θ_{n2A} relative to the light beam L1A corresponding to the first view position LCA is defined as follows.

θ_{n2A}=sin⁻¹{sin(θ_{n1A}/n2)}

Similarly, a refraction angle θ_{n2B} relative to the light beam L1B corresponding to the second view position LCB is defined as follows.

θ_{n2B}=sin⁻¹{sin(θ_{n1B}/n2)}

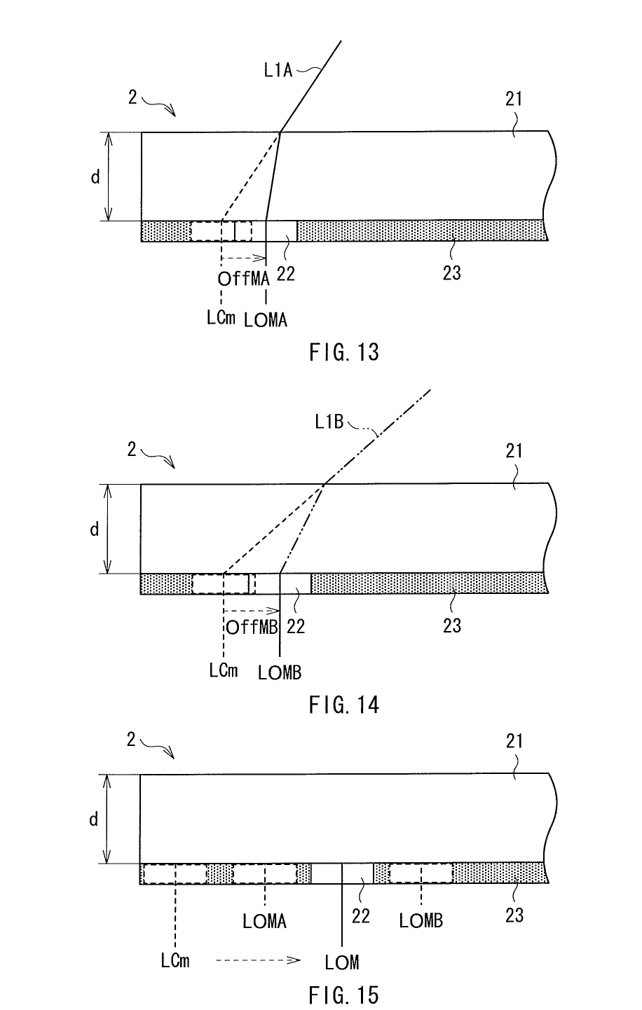

When the mid-position LCm before the optimization is observed from the first view position LCA, that mid-position LCm is observed as being displaced optically to the first displaced position LOMA due to the influence of the refractive index difference, as illustrated in FIG. 13. The amount of displacement OffMA in this case is defined as follows, where “d” is a thickness of the substrate 21.

OffMA=d{tan(θ_{n1A})−tan(θ_{n2A})}

The first displaced position LOMA is defined as follows.

LOMA=LCm−OffMA

Similarly, when the mid-position LCm before the optimization is observed from the second view position LCB, that mid-position LCm is observed as being displaced optically to the second displaced position LOMB due to the influence of the refractive index difference, as illustrated in FIG. 14. The amount of displacement OffMB in this case is defined as follows.

OffMB=d{tan(θ_{n1B})−tan(θ_{n2B})}

The second displaced position LOMB is defined as follows.

LOMB=LCm−OffMB

The foregoing description is directed to the calculation for the right side on the screen. In practice, a similar calculation is performed for the left side on the screen as well. It is to be noted, however, that a positional relationship of each section in the horizontal direction with respect to the first view position LCA and the second view position LCB is inverted because of the line symmetry.

In one embodiment where two viewpoints (the binocular scheme) is employed, two viewpoints including the right-eye 51R and the left-eye 51L at the single observed position are taken into account. In one embodiment where multiple viewpoints (three or more viewpoints) are employed, the outermost observed positions are defined as the first observed position A and the second observed position B as illustrated in FIG. 10, respectively, and the right-eye 51R in the first observed position A is defined as the first view position and the left-eye 51L in the second observed position B is defined as the second view position, to perform the similar calculation.

As illustrated in FIG. 15, the mid-position LOm following the optimization of the slits 22 may be set to the midpoint of the first displaced position LOMA and the second displaced position LOMB. In other words, the following is established.

LOM=(LOMA+LOMB)/2

### [Specific Example of Arrangement of Slits 22]

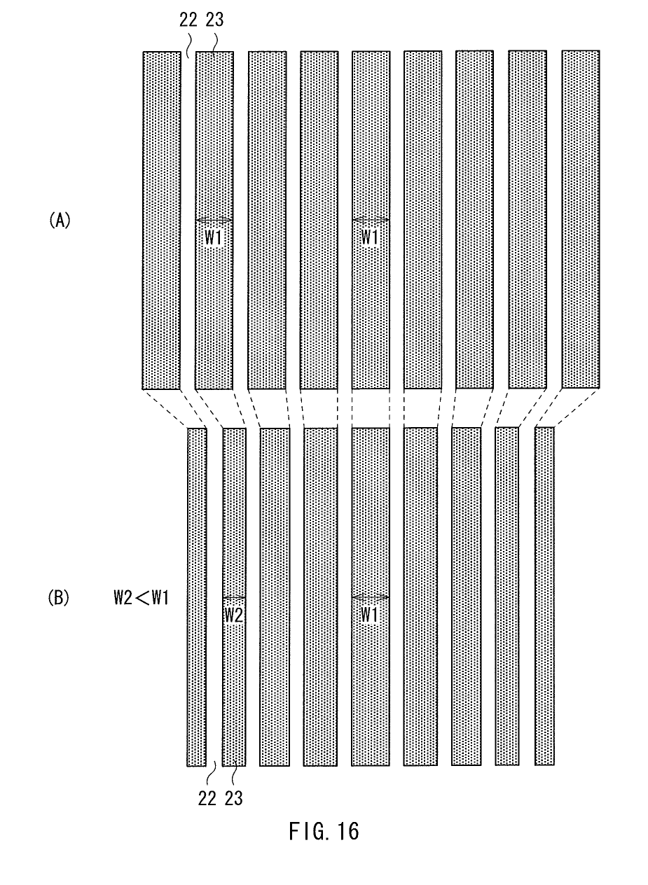

Specific examples of arrangement of the slits 22 in the barrier device 2 structured according to the optimization scheme described above will now be described with reference to FIGS. 16 to 18.

Part (A) of FIG. 16 illustrates a first specific example of the arrangement of the slits 22 before the optimization. Part (B) of FIG. 16 illustrates the first specific example of the arrangement of the slits 22 following the optimization. In the arrangement illustrated in (A) of FIG. 16 which is before the optimization, the slits 22 and the shielding sections 23 are alternately arranged in a vertical-stripe fashion. A barrier width (a width of the shielding section 23 or a “barrier pitch”) as denoted by a width W1 is the same in both the central region and the peripheral region. A width of the single slit 22 is the same in both the central region and the peripheral region. Thus, the pitch (or the “slit pitch”), which may be a center-to-center distance, of the neighboring slits 22 is the same in both the central region and the peripheral region. In contrast, in the arrangement following the optimization illustrated in (B) of FIG. 16, the barrier width has the width W1 in the central region, whereas the barrier width has a width W2 (<W1) in the peripheral region. Thus, the barrier width becomes narrower as approaching the outer side. The width of the single slit 22 is the same in both the central region and the peripheral region. Hence, the pitch (the slit pitch), i.e., the slit interval, of the neighboring slits 22 differs between the central region and the peripheral region, and thus the pitch becomes narrower as approaching the outer side. In other words, the intervals of the slits 22 decrease as an outward distance from a mid-position of the array increases.

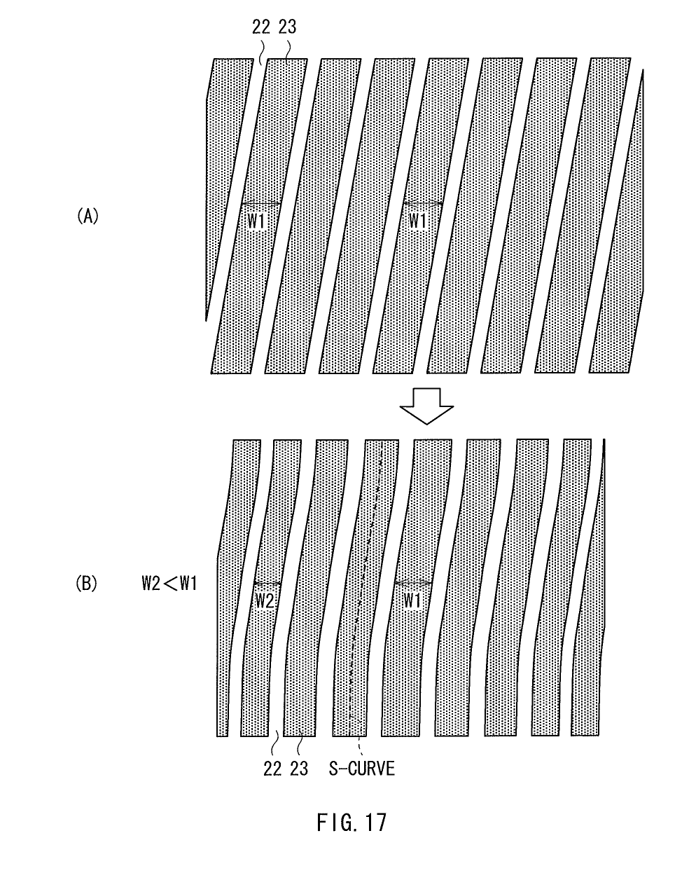

Part (A) of FIG. 17 illustrates a second specific example of the arrangement of the slits 22 before the optimization. Part (B) of FIG. 17 illustrates the second specific example of the arrangement of the slits 22 following the optimization. In the arrangement illustrated in (A) of FIG. 17 which is before the optimization, the slits 22 and the shielding sections 23 are alternately arranged in an oblique-stripe fashion. The barrier width is the same in both the central region and the peripheral region as denoted by the width W1. The width of the single slit 22 is the same in both the central region and the peripheral region. Thus, the pitch of the neighboring slits 22 is the same in both the central region and the peripheral region. In contrast, in the arrangement following the optimization illustrated in (B) of FIG. 17, the slits 22 and the shielding sections 23 are so alternately arranged in an oblique-stripe fashion as to form an alphabet S-like curve (an inverted-S-like curve). In other words, the plurality of slits 22 are arranged in the oblique-stripe fashion, and each of the plurality of slits 22 forms substantially the inverted-S-like curve. The barrier width has the width W1 in the central region, whereas the barrier width has a width W2 (<W1) in the peripheral region, and thus the barrier width becomes narrower as approaching the outer side. The width of the single slit 22 is the same in both the central region and the peripheral region. Hence, the pitch of the neighboring slits 22 differs between the central region and the peripheral region, and thus the pitch becomes narrower as approaching the outer side. In other words, the intervals of the slits 22 decrease as an outward distance from a mid-position of the array increases.

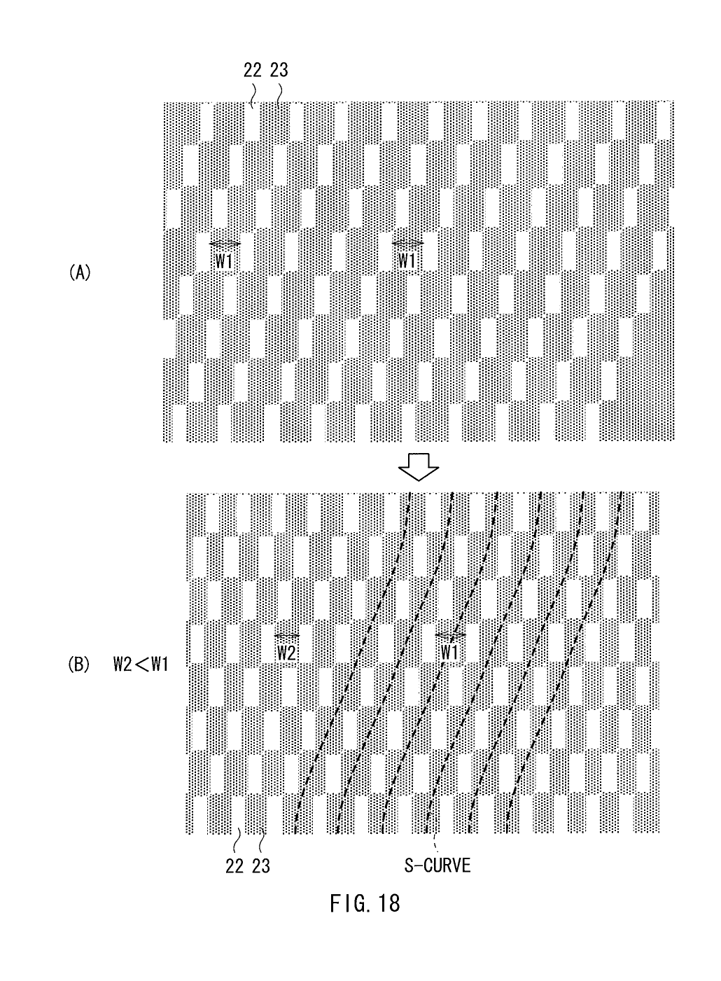

Part (A) of FIG. 18 illustrates a third specific example of the arrangement of the slits 22 before the optimization. Part (B) of FIG. 18 illustrates the third specific example of the arrangement of the slits 22 following the optimization. In the arrangement illustrated in (A) of FIG. 18 which is before the optimization, the slits 22 are arranged in a stepwise fashion linearly in an oblique direction. The barrier width is the same in both the central region and the peripheral region as denoted by the width W1. The width of the single slit 22 is the same in both the central region and the peripheral region. Thus, the pitch of the neighboring slits 22 is the same in both the central region and the peripheral region. In contrast, in the arrangement following the optimization illustrated in (B) of FIG. 18, the slits 22 are so arranged in a stepwise fashion to form an alphabet S-like curve (an inverted-S-like curve) in the oblique direction. In other words, the plurality of slits 22 are arranged to form a plurality of slit groups, and each of the slit groups includes the slits 22 arranged in the oblique direction in the stepwise fashion to form substantially the inverted-S-like curve. The barrier width has the width W1 in the central region, whereas the barrier width has a width W2 (<W1) in the peripheral region, and thus the barrier width becomes narrower as approaching the outer side. The width of the single slit 22 is the same in both the central region and the peripheral region. Hence, the pitch of the neighboring slits 22 differs between the central region and the peripheral region, and thus the pitch becomes narrower as approaching the outer side. In other words, the intervals of the slits 22 decrease as an outward distance from a mid-position of the array increases.

### [Effect]

According to the stereoscopic display unit and the barrier device 2 of the embodiment of the disclosure described above, the intervals of the plurality of slits 22 become narrower as approaching the peripheral region from the central region. In other words, the intervals of the plurality of slits decrease as the outward distance from the mid-position of the array increases. This makes it possible to, when a plurality of layers having a refractive index difference are interposed between the display section 1 and the slits 22, compensate the optical displacements in locations of the slits 22 caused by that refractive index difference. Hence, it is possible to perform excellent stereoscopic displaying.

### Other Embodiments

Although the technology has been described in the foregoing by way of example with reference to the embodiment, the technology is not limited thereto but may be modified in a wide variety of ways.

Accordingly, it is possible to extract at least the following configurations from the above-described exemplary embodiment of the disclosure.

(1) A stereoscopic display unit, including:

a display section; and

a barrier device disposed on a rear side of the display section to include a plurality of slits allowing image-displaying light beams to pass therethrough toward the display section,

wherein the plurality of slits are arranged in a fashion of an array at horizontal intervals which decrease as an outward distance from a mid-position of the array increases.

(2) The stereoscopic display unit according to (1), further including:

a first layer provided between the barrier device and the display section, the barrier device being disposed to face the display section with the first layer in between; and

a second layer provided between the plurality of slits and the first layer, and having a refractive index different from that of the first layer.

(3) The stereoscopic display unit according to (2), wherein the horizontal intervals of the plurality of slits are optimized to compensate optical displacements in slit locations caused by a refractive index difference between the first layer and the second layer.
(4) The stereoscopic display unit according to (3), wherein an optimized mid-position of each of the plurality of slits is located at a midpoint between a first displaced position LOMA and a second displaced position LOMB, where:

the first displaced position LOMA is defined as an observed position which is optically displaced due to the refractive index difference, the observed position being obtained in an observation of a non-optimized mid-position LCm from a first view position under presence of the refractive index difference, the first view position being defined as one of outermost positions within a range of an effective viewing angle;

the second displaced position LOMB is defined as an observed position which is optically displaced due to the refractive index difference, the observed position being obtained in an observation of the non-optimized mid-position LCm from a second view position under presence of the refractive index difference, the second view position being defined as another of the outermost positions within the range of the effective viewing angle; and

the non-optimized mid-position LCm is defined as an observed position which is obtained in an observation of a mid-position of each of the plurality of slits before the optimization from the first and the second view positions under absence of the refractive index difference.

(5) The stereoscopic display unit according to any one of (2) to (4), wherein an air layer corresponds to the first layer, and a substrate of the barrier device corresponds to the second layer.
(6) The stereoscopic display unit according to any one of (1) to (5), wherein the plurality of slits are arranged in an oblique-stripe fashion, each of the plurality of slits forming substantially an inverted-S-like curve.
(7) The stereoscopic display unit according to any one of (1) to (5), wherein the plurality of slits are arranged to form a plurality of slit groups, each of the slit groups including slits arranged in an oblique direction in a stepwise fashion to form substantially an inverted-S-like curve.
(8) A barrier device, including:

a plurality of slits allowing image-displaying light beams to pass therethrough,

wherein the plurality of slits are arranged in an array at horizontal intervals which decrease as an outward distance from a mid-position of the array increases.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A stereoscopic display unit, comprising:
a display section; and
a barrier device disposed on a rear side of the display section to include a plurality of slits allowing image-displaying light beams to pass therethrough toward the display section,
wherein the plurality of slits are arranged in a fashion of an array at horizontal intervals which decrease as an outward distance from a mid-position of the array increases.

2. The stereoscopic display unit according to claim 1, further comprising:
a first layer provided between the barrier device and the display section, the barrier device being disposed to face the display section with the first layer in between; and
a second layer provided between the plurality of slits and the first layer, and having a refractive index different from that of the first layer.

3. The stereoscopic display unit according to claim 2, wherein the horizontal intervals of the plurality of slits are optimized to compensate optical displacements in slit locations caused by a refractive index difference between the first layer and the second layer.

4. The stereoscopic display unit according to claim 3, wherein an optimized mid-position of each of the plurality of slits is located at a midpoint between a first displaced position LOMA and a second displaced position LOMB, where:
the first displaced position LOMA is defined as an observed position which is optically displaced due to the refractive index difference, the observed position being obtained in an observation of a non-optimized mid-position LCm from a first view position under presence of the refractive index difference, the first view position being defined as one of outermost positions within a range of an effective viewing angle;
the second displaced position LOMB is defined as an observed position which is optically displaced due to the refractive index difference, the observed position being obtained in an observation of the non-optimized mid-position LCm from a second view position under presence of the refractive index difference, the second view position being defined as another of the outermost positions within the range of the effective viewing angle; and
the non-optimized mid-position LCm is defined as an observed position which is obtained in an observation of a mid-position of each of the plurality of slits before the optimization from the first and the second view positions under absence of the refractive index difference.

5. The stereoscopic display unit according to claim 2, wherein an air layer corresponds to the first layer, and a substrate of the barrier device corresponds to the second layer.

6. The stereoscopic display unit according to claim 1, wherein the plurality of slits are arranged in an oblique-stripe fashion, each of the plurality of slits forming substantially an inverted-S-like curve.

7. The stereoscopic display unit according to claim 1, wherein the plurality of slits are arranged to form a plurality of slit groups, each of the slit groups including slits arranged in an oblique direction in a stepwise fashion to form substantially an inverted-S-like curve.

8. A barrier device, comprising:
a plurality of slits allowing image-displaying light beams to pass therethrough,
wherein the plurality of slits are arranged in an array at horizontal intervals which decrease as an outward distance from a mid-position of the array increases.
